(19) United States
(12) Patent Application Publication
(10) Pub. No.: US 2019/0026820 A1
(43) Pub. Date: Jan. 24, 2019

(54) Method and System for an Electronic Marketplace for Secure Collaboration Between Government Contractors, Grantees, and Grant and Proposal Professionals

(71) Applicants: Eric A. Adolphe, Vienna, VA (US); Dwayne Robinson, Clarksville, MD (US); Andrea D Dougherty, Elkridge, MD (US); Robert B Dickson, Fairfax, VA (US); Bhargav P. Upender, Potoma, MD (US)

(72) Inventors: Eric A. Adolphe, Vienna, VA (US); Dwayne Robinson, Clarksville, MD (US); Andrea D Dougherty, Elkridge, MD (US); Robert B Dickson, Fairfax, VA (US); Bhargav P. Upender, Potoma, MD (US)

(73) Assignee: Government Proposal Solutions, Inc.

(21) Appl. No.: 14/833,820

(22) Filed: Aug. 24, 2015

Related U.S. Application Data
(60) Provisional application No. 62/040,415, filed on Aug. 22, 2014.

(51) Int. Cl. G06Q 30/08; G06Q 50/26; G06Q 10/10; G06Q 10/06

(52) U.S. Cl. CPC G06Q 30/08; G06Q 10/06393; G06Q 10/10; G06Q 50/26

(57) ABSTRACT

The functions and operations of a matching service and electronic process solutions are disclosed. This includes the identification of multiple candidates to participate in a reverse auction process. The parties will exchange information in a prescribed format. Following an automated bidding process and selection of the winning proposal, communications will take place between the selecting and the selected party to enable performance of the work proposed. Upon delivery and acceptance of the service, payment is made and user satisfaction is measured and documented. Related functions and operations include electronic payment, performance measurement and secure collaboration tools.

### CROSS-REFERENCE TO RELATED APPLICATION

This application claims the benefit of to U.S. Provisional Patent Application No. 62/040,415, filed Aug. 22, 2014, and entitled Method And System For An Electronic Marketplace For Secure Collaboration Between Government Contractors, Grantees, And Grant And Proposal Professionals, the disclosure of which is incorporated in its entirety by reference.

### BACKGROUND

The present invention relates generally to methods and systems for the operation of a marketplace for professionals.

### SUMMARY OF INVENTION

The present invention relates to the functions and operation of a one-stop marketplace for Government proposal and grant development support. This solution effectively combines knowledge management, workflows, human resources and information technology into a suite of complementary services to streamline the marketplace, improve service, save time, reduce costs, and generate winning proposals and grant applications that are on par with products developed by Fortune 100 corporations. The invention helps individuals, private companies, Government agencies, non-governmental organizations, academic institutions, and non-profit organizations produce proposals and apply for grants more effectively and efficiently to meet Government requirements. The invention provides a secure communications exchange environment and a one-stop professional marketplace matching Buyers with Experts selling proposal, grant, tender, and cooperative agreement development goods and services necessary to create a complete and compliant proposal, grant, tender, or cooperative agreement package.

By leveraging knowledge management, rules engines, and business techniques, the invention creates a combination of high quality tools and capabilities to produce improved levels of service and a greater assurance that the delivered proposal, grant, tender or cooperative agreement is complete. The invention creates a unified set of methods and systems devoted to simplifying the process of responding to government solicitations and applications, reducing costs to participate in public procurements, and enhancing the quality of proposals.

The present invention enables companies and organizations to identify their specific requirements for proposal support by labor category, level of effort and timing of the delivery of service.

As a result of the methods and systems incorporated into this invention, an organization with no idea of where their next opportunity is coming from, or how they will respond, will be able to access the system and find the capabilities required to answer their questions. In a preferred embodiment, organizations may research opportunities, select a project of interest, identify the talent and staff resources required, and produce a professional proposal or grant application, which can then be produced in final form and delivered to a Government or Intergovernmental Organization including but not limited to the United Nations, North Atlantic Treaty Organization (NATO), and the World Bank.

Through the use of empirical data and standardized techniques, the present invention may quantify and assign a value to various factors having a bearing on the probability of winning a given proposal opportunity. In an embodiment, the quality of baseline data, the thoroughness of the analysis, and the granularity of the probability criteria and the format of presentation may be factors. Once the tool determines that probability of award, the system matches the company with experts who are able to address the company's weaknesses and help the company improve its probability of win by enhancing the company's price, technical solution, corporate experience, presentation of key personnel and any other Government award or selection criteria.

The present invention solves the problem of protecting the intellectual property contained in various versions of draft proposals and the final product. It also helps protect the integrity of the competitive system. After acceptance of the expert or team's work, the expert or team receives payment, the company receives the documents, and the documents are automatically deleted from all expert's or team's computers. This prevents freelance experts from reusing proposal or grant material developed on behalf of one company to the benefit of another company in violation of non-disclosure agreements. This system also prevents companies that reject the expert or team's work from using that work without paying for it. If the company chooses to not accept the work, the documents are automatically deleted from the company's computers and mobile devices, as well as from the expert's or team's computers and mobile devices.

The present invention solves a major problem for experts, consultants and freelancers involving timely payment for delivered services. By establishing an escrow account at the beginning of the effort, and reserving payment in advance, the invention provides a mechanism for immediate payment upon acceptance of those services by the company. In exchange, companies are assured a highly competitive work arrangement including price, determined in advance through the market forces of a large audience of qualified experts bidding in a reverse auction. If the company rejects the expert's or consultant's work, the system automatically deletes the work products from the company and expert's and consultant's computers, and automatically attempts to match the company with another consultant or team.

The present invention is designed to collect and organize data and win rates and information about company experiences with consultants and experts who provide service through the use of the system. The information provides a rating from 1-5 stars and provides for an additional narrative rating. The present invention also displays the win rates of the team and or individual expert. This information is provided on a team profile and also on the individual's biographical summary, and enables current companies to rate the performance they received, and future potential companies to determine the sort of quality performance they might expect. The virtual team scoreboard enables an annual competition to award success bonuses based on win rates and company satisfaction to teams and individual experts.

The present invention provides a secure collaboration environment to enable team members to effectively work on proposals from various locations without requiring an office or their physical presence. In addition to being a secure electronic system for communicating and sharing information, the tool enables team members to access research and knowledge management resources, databases and pricing information to combine all aspects of the proposal development process effectively and efficiently.

Experts may also be selected to perform reviews, assess proposal or performance risks, develop non-disclosure agreements, develop Organizational Conflicts of Interest (OCI) mitigation plans, develop compliance documents, or other ancillary tasks necessary to complete a proposal, grant application, tender, or cooperative agreement.

An exemplary embodiment of a computer implemented method for identifying a seller for receiving a buyer request for a seller, creating a buyer posting, the buyer posting indicating a government contract or grant, creating multiple seller profiles, each seller profile created by a separate seller, wherein the buyer requests bids from the sellers, and wherein the buyer selects desired seller.

A system for identifying a seller including a buyer terminal, wherein a buyer can request a seller, a seller terminal, wherein a seller can create a profile, wherein the buyer can post a government contract or grant, wherein the seller can post a bid, and wherein the buyer selects desired seller.

A method of selecting a proposal professional including receiving a buyer request for a seller at a buyer terminal, creating a buyer posting, the buyer posting indicating a government contract or grant; creating multiple proposal professional profiles, each proposal professional profile created at a separate seller terminal, wherein the buyer requests bids from the multiple proposal professionals, and wherein the buyer selects the desired proposal professional.

Embodiments may include a method and system for identifying subject matter experts who are likely to be successful in developing proposals and applications for Government contracts and grants.

Embodiments may include method and system for estimating probability of award of a Government contract or grant.

Embodiments may include method and system for automated reverse auction of proposal development and grant application project costs.

Embodiments may include method and system for establishing virtual high performance teams to respond to Government solicitations, task orders, and completing grant applications.

Embodiments may include method and system for project acceptance and payment of Government proposal developers and grant application writers.

Embodiments may include method and system to maintain a virtual proposal team scoreboard.

Embodiments may include method and system for development and issuance of a consolidated IRS Form 1099 for Government proposal and grant application experts.

Embodiments may include method and system to securely transfer Government proposals and grant applications between buyers and proposal experts to prevent accidental and unauthorized disclosures.

Embodiments may include method and system to perform electronic review of proposal or grant win or loss and generate an automated electronic debrief report.

Embodiments may include method and system to enable companies to electronically buy, sell, and trade Government contracts and grants.

Embodiments may include method and system to enable companies to electronically buy, sell, and trade staffing positions on Government contracts.

Embodiments may include method and system to enable companies to electronically buy, sell, and trade pre-existing bid and proposal templates.

Embodiments may include a method and system to store proposal and grant templates including technical, price, experience, resume, and other templated sections to enable rapid response to task order requests for proposals.

Embodiments may include method and system to electronically overlay proposal development cycle on a schedule with automated reminders of key activities for each phase of the proposal development cycle.

Embodiments may include method and system to electronically select subcontractors and suppliers to form a team to pursue Government contracts and tenders, and grants.

Embodiments may include method and system to electronically push solicitations, tenders, grants, cooperative agreements, and invitations for bids to companies based on the company's core competencies, products, experience, and other attributes and areas of interest identified by the company.

Embodiments may include method to electronically estimate the price to complete a Government proposal, tender, grant application, or cooperative agreement.

Embodiments may include method to electronically initiate a background investigation of freelance government proposal, grant, tender, and cooperative agreement consultants.

Embodiments may include method to electronically match resumes to personnel including key personnel requirements identified in the Government's solicitation, grant, tender, or cooperative agreement documents.

Embodiments may include method to electronically display a dashboard of project profiles.

Embodiments may include method to insert resumes into a proposal document.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. In the drawings:

FIG. 1 illustrates a diagram of a system including a preferred embodiment of the present invention;

FIG. 2 illustrates a diagram of an example application server site;

FIG. 3 illustrates a block diagram of the preferred embodiment to provide secure communications and exchange of proprietary proposal and grant information to prepare responses for submission to a government agency;

FIG. 4 illustrates a block diagram of buyer calculating probability of winning a government contract, tender, or grant and determining whether to continue the project or abandon the project;

FIG. 5a shows a rule base encoded into a rules engine to determine probability of winning a government contract, tender, or grant;

FIG. 5b shows a rule base encoded into a rules engine to generate report and instructions to increase win probability;

FIG. 6 shows information needed to initiate a project;

FIG. 7 shows information needed for reverse auction price estimator rules base;

FIG. 8 illustrates an embodiment of reverse auction;

FIG. 9a shows rules needed for matching rules base;

FIG. 9b shows rules needed for ranking experts;

FIG. 9c shows sample result of ranked high performance teams;

FIG. 9d shows sample result of ranked qualified sellers;

FIG. 10 shows screen shot of seller's profile page;

FIG. 11 shows verification levels of sellers;

FIG. 12 illustrates a block diagram of buyer acceptance of final document;

FIG. 13 illustrates a block diagram of buyer rejecting final document;

FIG. 14 shows an example proposal development workflow;

FIG. 15 illustrates an example of Trading Post to enable a plurality of buyers to buy, sell, and trade Government contracts and positions;

FIG. 16 shows pipleline tool feature; and

FIG. 17 shows the detail drill down of the pipeline tool feature.

### DETAILED DESCRIPTION

Governments at all levels and in all parts of the world use contracts, grants, tenders, and cooperative agreements as primary tools to carry out public policy and deliver services. Typically these legal instruments are awarded as part of a competitive process involving solicitations, grant applications, cooperative agreements, or tenders. In the United States, contracts are awarded following the issuance of a request for proposals, while grants and cooperative agreements are awarded following an application process. Other countries use similar methods including tenders.

Commercial companies, universities and non-profit organizations who seek to win tenders, cooperative agreements, contracts or grant awards, usually are required to submit detailed proposals or applications describing their approach, technical solutions, resumes, product descriptions, price, and cost information. Also, many Government agencies such as State Government Agencies also prepare proposals and grant applications in response to United States Federal or Foreign Central Government invitations or request for proposals. Following an evaluation process, Governments select the winning bid or offer

Historically, businesses and non-profit organizations employed substantial staffs comprised of contract or grant specialists, proposal managers, proposal coordinators, language translators, attorneys, technical solution architects, compliance experts, recruiters, graphics artists and pricing experts who teamed to develop winning proposals. These experts helped prepare professional quality proposals, grants, and cooperative agreements and assisted in assuring that complex legal and business requirements were met.

In the past decade there has been a fundamental shift in the way organizations do business. Many no longer have staffs of professionals dedicated to preparing proposals to secure new opportunities. Instead, they rely upon part time or temporary consultants and independent operators, who typically are former corporate employees, who move from one short-term engagement to another. Organizations often engage in inefficient negotiations with individual consultants to form on demand teams to respond to Government solicitations and grants.

Technological advancements over the past ten years have led to an electronic job market for consultants and temporary personnel. Businesses and non-profits frequently rely upon such personnel. While this process can produce qualified candidates, getting the right people is cumbersome and time consuming. Often organizations have to use multiple service providers to find the right candidate or candidates to form a team of proposal or grants development specialists.

Government contract and grant procedures are highly regulated and complex by their nature. Literally thousands of laws, regulations and court decisions govern their use. This is a discreet community of practice managed professionals and requiring a specific body of knowledge and very specialized skill sets. Companies and organizations seeking to do business in this environment require resources for research and analysis, training, mentoring and related support services.

The confluence of market forces which have driven organizations to seek temporary outside proposal assistance, rely upon highly fragmented and generalized hiring tools and compete in an increasingly complicated and demanding business environment has created an inefficient and difficult work environment. Small businesses and organizations have been particularly hard hit, and have no readily available place to go for relief. In some cases the costs of operating under these circumstances have become prohibitive and are leading to greater overall costs due to lost competition and inefficiency.

The confluence of market forces which have driven organizations to seek temporary outside proposal assistance, rely upon highly fragmented and generalized hiring tools and compete in an increasingly complicated and demanding business environment has created an inefficient and difficult work environment. Small businesses and organizations have been particularly hard hit, and have no readily available place to go for relief. In some cases the costs of operating under these circumstances have become prohibitive and are leading to greater overall costs due to lost competition and inefficiency.

An exemplary embodiment relates to the methods and systems of a one-stop marketplace for government proposal, tender, grants, and cooperative agreement development support. The preferred embodiment may provide methods and systems to securely write and price proposals in response to government solicitations for contracts and applications for grants. The preferred embodiment may provide access to professional experts and specialists, in-depth research, knowledge management and automated systems to provide support throughout the entire proposal, tender, and grant life cycles.

An exemplary embodiment identifies proposal and grants professionals and other subject matter experts who are likely to be successful in developing proposals for contracts, tenders, and applications for grants. The preferred embodiment may create a universe of qualified proposal experts and specialists within the discreet proposal professional community of practice. Experts are then ranked by their experience responding to bid invitations from specific Government bodies, prior successes or win rates, customer satisfaction, availability, criminal, credit, and client reference checks, record of on time completion of previous projects, security clearances, and industry certifications. The preferred embodiment may also prevent experts from working on the same project but for different companies avoiding a chronic problem of conflicts of interests within the community of practice.

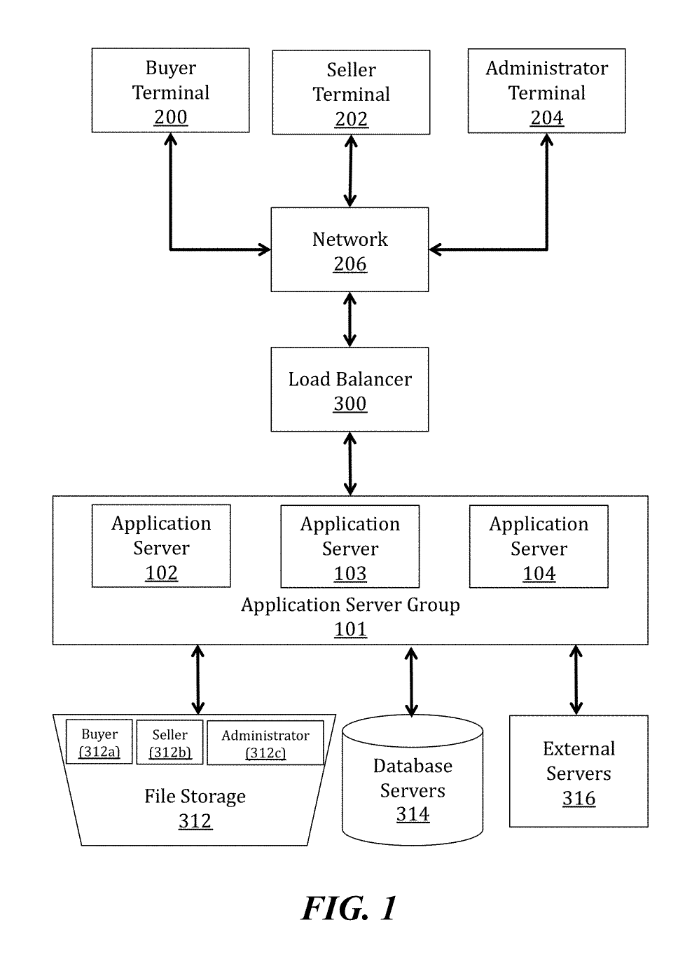

FIG. 1 shows a diagram of a system including a preferred embodiment of the invention. Buyer terminal 200, seller terminal 202 and administrator terminal 204 communicate with application server group 101 via network 206 and load balancer 300. Buyer terminal 200, seller terminal 202 and administrator terminal 204 may be any desktop computer, laptop computer, notebook computer, electronic reader, tablet computer, smart phone, cellular phone, mobile device, or any other device capable of accessing the application server group.

Buyer terminal 200 may be accessed by buyers from multiple different groups. The groups could be commercial companies, universities, non-profit organizations, state and local government agencies, and non-governmental organizations. The buyers are not limited to only the above named entities. The buyers could be groups from any organization, company or entity seeking proposal professionals or proposal services.

Seller terminal 202 may be accessed by sellers within the group of commercial companies, proposal and grant professionals, subject matter experts, consultants and other professional and experts, such as, but not limited to, pricing professionals, technical subject matter experts, contracts specialists, legal professionals, recruiters, printers/production professionals, document translators, oral presentation specialists, grant writers, business development professionals, capture managers, proposal writers, resume writers, proposal reviewers, proposal coordinators, proposal managers, past performance specialist, corporate experience specialists, data analyst, solutions architect, presentation development manager, risk assessors, compliance experts, attorneys, copy editors, strategists, program managers, project managers, contract managers, facility security officers, export control specialists, and product managers.

Administrator terminal 204 may be accessed by authorized users of the system. Load balancer 300 selects which of the servers 102, 103, or 104 receives a request from the user of buyer terminal, seller terminal or administrator terminal. Load balancer 300 distributes user connections to each server. Application server group 101 may include application servers 102, 103 and 104. Although, in this embodiment, the application server group 101 is shown as a group of three servers, however, many more may be used or just one

File Storage 312 may be any file structure or virtual library for permanent or temporary storage of files. Buyer, seller or administrator may manage files in file storage 312. Buyer, seller and administrator may each have their own file storage. Buyer file storage 312a stores buyer's files. Seller file storage 312b stores seller's files. Administrator file storage 312c stores administrator files. The types of files may include, but not limited to, debriefs, proposal templates including price, technical, experience, resume, and other proposal sections, Non-Disclosure Agreements between buyer and seller, temporary copies of proposals, grants, tenders or cooperative agreement documents and metadata. File storage 312 may create a virtual proposal library including private folders and shared folders for each user. In an embodiment, application server group 101 requires Hypertext Transfer Protocol Secure (HTTPS) for secure communications with external servers 316. Further, application server group 101 encrypts all files in 312 and data at rest in database servers 314. Database server 314 may be separated from the application server group 101 to enhance security of data against hacking. In another embodiment, database server 314 forbids Structured Query Language (SQL) injection attacks to enhance the security and integrity of data.

In an embodiment, the buyer may invite sellers and other buyers to retrieve specific documents in the buyer's file storage 312a. The buyer retains control of all documents in the buyer's file storage 312a and may rescind access privileges to seller or other buyers. In another embodiment, seller may retrieve files from seller's file storage 312b and buyer's file storage when invited by buyer. Further, in another embodiment, administrator may retrieve any files from all file storage, including buyer's file storage, seller's file storage and administrator file storage.

Database Servers 314 may be any memory device. Data may include, but not limited to, directory of all sellers and buyers, data from rules engine, data from team scoreboard, trending data, transactions data, workflow data, project posting data, proposal professional verification data, alert and push notifications data.

External Servers 316 may include commercial resume systems, external market intelligence systems, solicitation, grant, tender, and cooperative agreement release and award notification systems, and commercial tax forms generator.

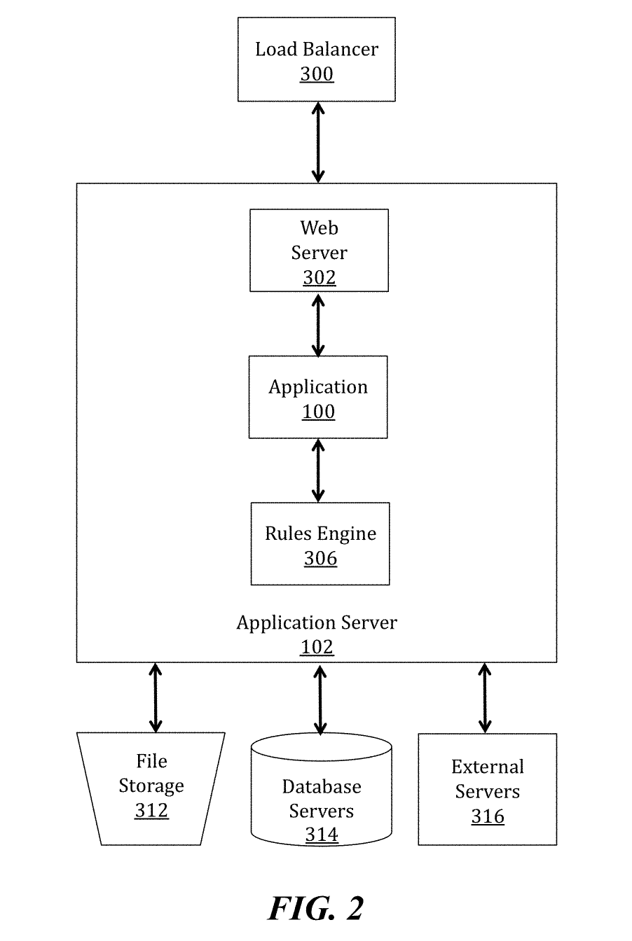

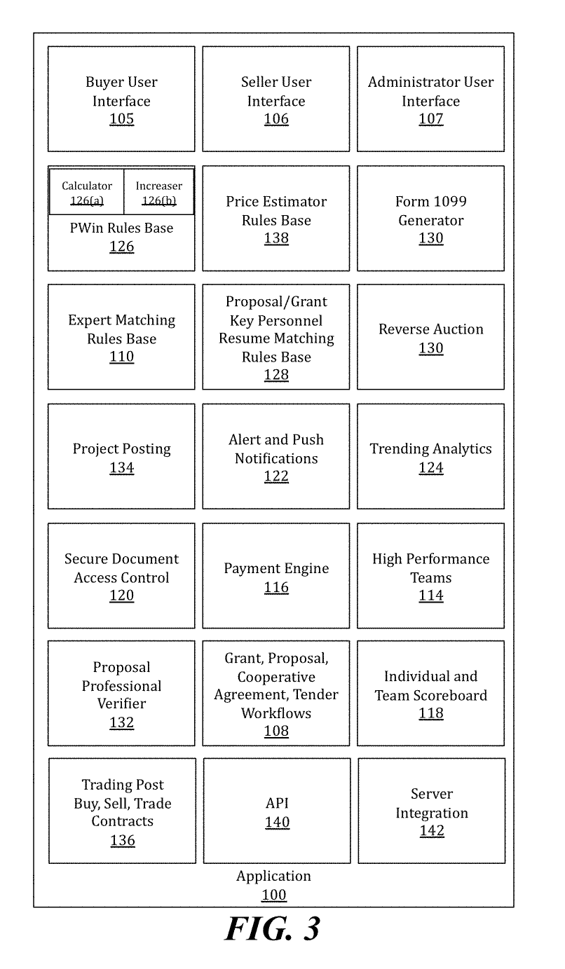

FIG. 2 shows a diagram of Application Server 102. The application 100 may implement steps necessary to communicate with the buyer terminal 200, seller terminal 202 and administrator terminal 204 via web server 302 and load balancer 300. The rules engine 306 may process events and generate instructions to the application 100. Rules engine 306 may retrieve information from buyers and sellers and derives results called by application 100. Rules bases in rules engine may include buyer and seller matching, probability of win (PWin), PWin increaser, price estimator, resume matching, and Trading Post 136 project matching. Rules engine may also provide alerts based on user input and information received from trending analytics 124, individual and team scoreboard 118, payment engine 116, PWin rules base 126, and other information further described in FIG. 3. In a preferred embodiment, rules engine fires rules simultaneously, thereby eliminating any delay or lag of response.

FIG. 3 shows details of application 100 to provide secure communications and exchange of proprietary proposal and grant information to prepare responses for submission to a Government or Intergovernmental agency. The application may include buyer user interface 105, seller user interface 106, administrator user interface 107, PWin calculator/increaser rules base 126, price estimator rules base 138, Form 1099 generator 130, expert matching rules base 110, proposal/grant key personnel resume matching rules base 128, reverse auction 130, project posting 134, alert and push notifications 122, trending analytics 124, secure document access control 120, payment engine 116, high performance teams 114, proposal professional verifier 132, grant, proposal, cooperative agreement, tender workflows 108, individual and team scoreboard 118, trading post to buy, sell, trade contracts 136, application programming interface (API) 140, and external server integration 142.

Buyer user interface 105 may provide all information that buyer needs to interact, communicate or exchange data with sellers and manage buyer's account.

Seller user interface 106 may provide all information that seller needs to interact, communicate or exchange data with buyers and manage seller's account.

Administrator user interface 107 may provide authorized users access to system security and maintenance, access to all files, monitor system performance, ability to intervene in case of disputes, perform system enhancements, delete accounts for any user violating terms of use, remove any content that violates terms of use, and other uses.

In an exemplary embodiment, the buyer may identify a Government generated request for proposal, tender, grant application, or cooperative agreement that the buyer wishes to pursue. In another preferred embodiment, the buyer may receive a list of recommended contracts, grants, tenders, or cooperative agreements to pursue through the alert and push notifications 122. Once the contract, grant, tender, or cooperative agreement is identified, the buyer inputs information from the Government agency's documents into the PWin calculator rules base 126a to determine likelihood of success.

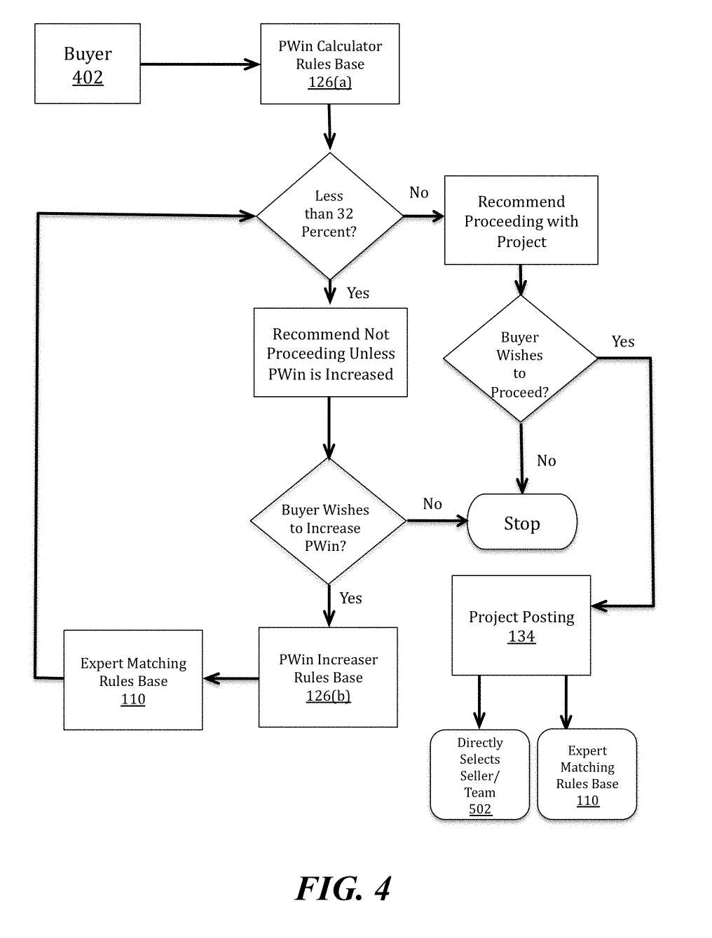

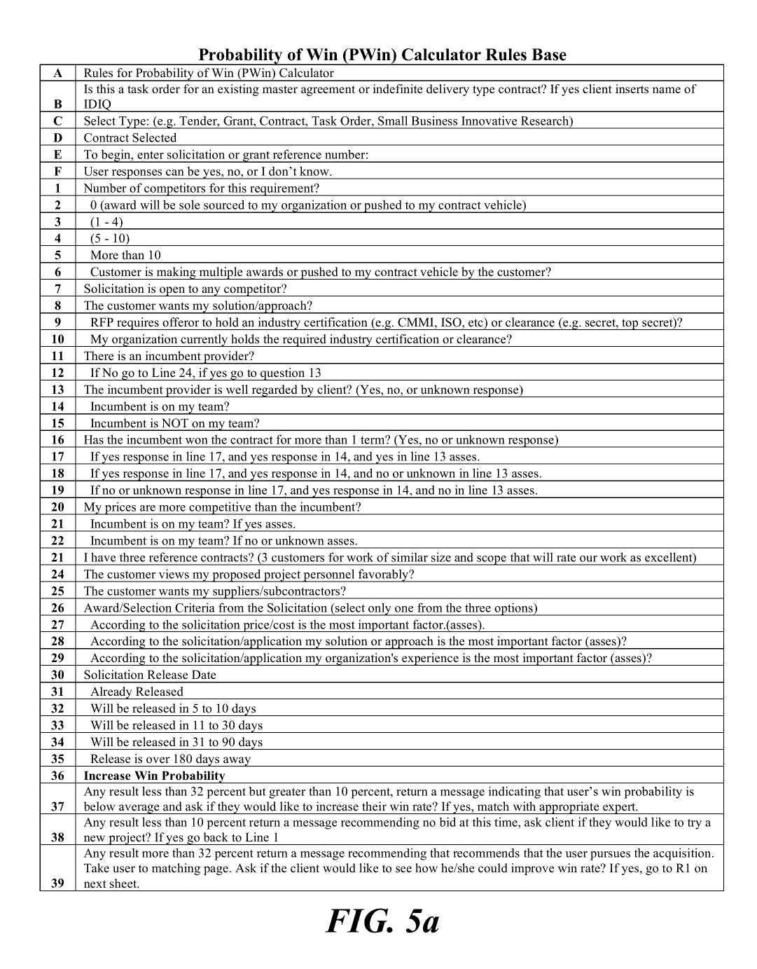

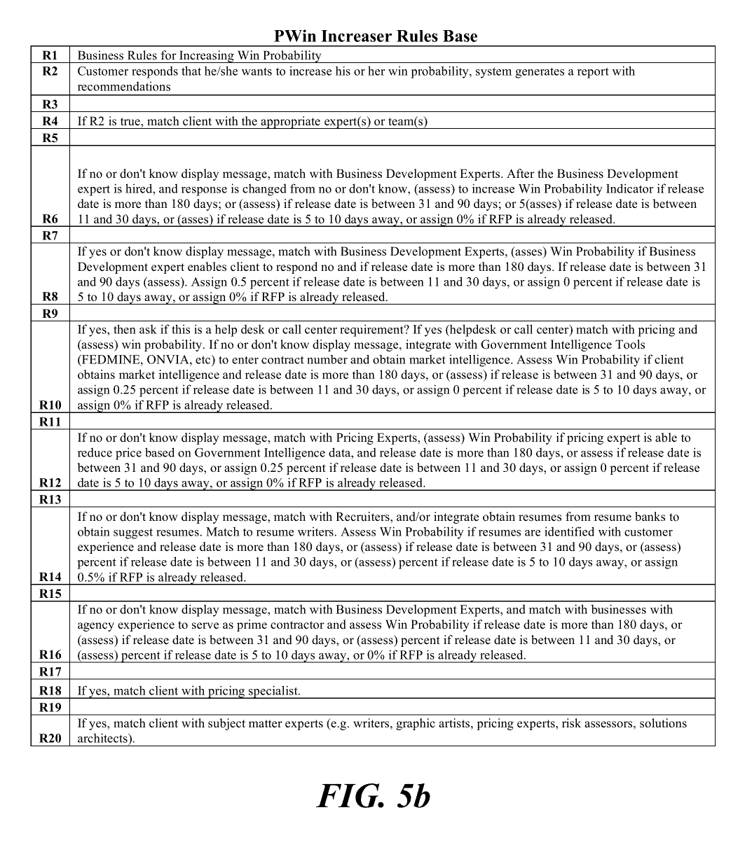

FIG. 4 shows a diagram of buyer utilizing the PWin calculater/increaser rules base to determine the probability of winning the identified opportunity which may be a contract, grant, tender or cooperative agreement. Buyer inputs data shown in FIG. 5a into PWin calculator 126a. PWin calculator 126a generates probability of win percentage. If percentage is less than 32 percent, then PWin calculator recommends not to bid on the identified opportunity or utilize PWin increaser 126b to increase probability of winning the identified opportunity. Buyer may input data shown in FIG. 5b into PWin increaser 126b. PWin increaser 126b generates matches to sellers via expert matching rules base 110 who can assist in increasing the PWin.

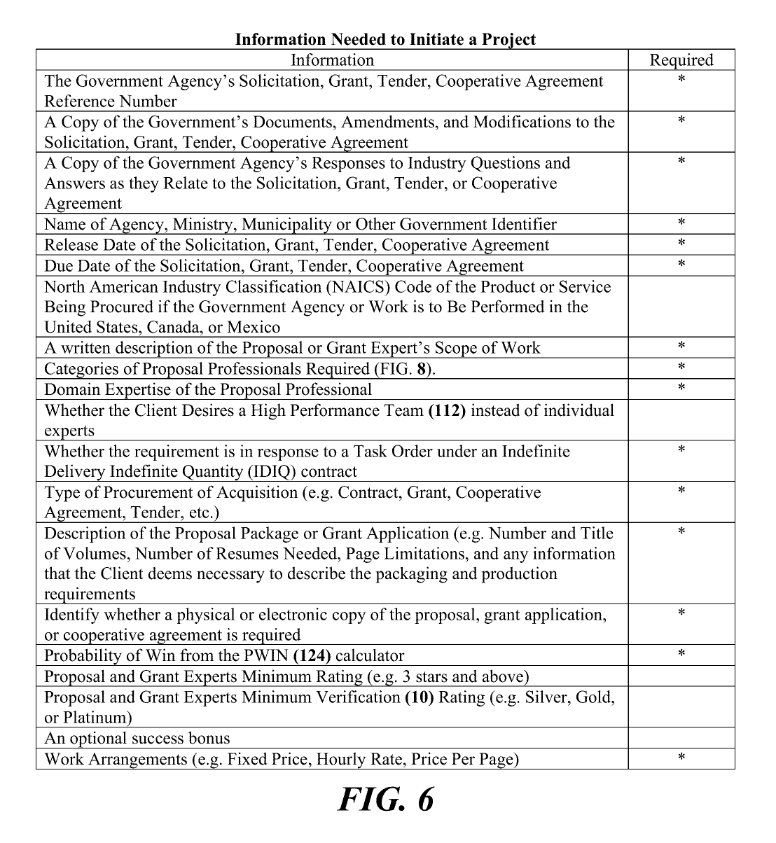

If buyer is satisfied with original PWin or adjusted PWin, buyer may enter information from the Government solicitation, tender, or application documents, and project requirements shown in FIG. 6 onto project posting 134. In an embodiment, step 502 shows buyer may directly select a known seller, plurality of sellers or team to complete the entire project or any part thereof. Buyer may have had prior interaction with seller, plurality of sellers or team and desires to continue a business relationship with them.

In another embodiment, expert matching rules base 110 automatically matches buyer's project posting to qualified sellers. In an embodiment, buyer may request open bids or provide a budget based on results of price estimator rules base 138. Open bids provides no limitations on the amount a seller bids for the project. In another embodiment, budgets may provide a maximum bid amount for the project. Further, in another embodiment, buyer may include a bonus to the project requirement to attract more sellers providing bids.

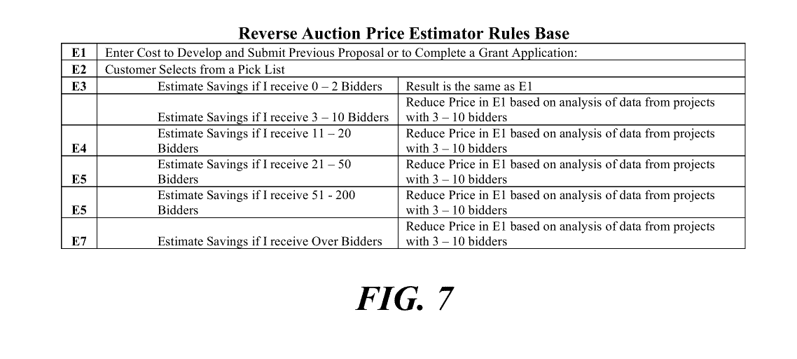

Budget may be determined by price estimator rules base 138. Buyer may enter information shown in FIG. 7 into price estimator rules base 138. Buyer may enter the cost to develop a proposal, tender, grant or other invitation from previous projects into price estimator rules base 138. Price estimator rules base 138 calculates the expected costs to develop the identified proposal, tender, grant application or cooperative agreement if the buyer uses reverse auction 130.

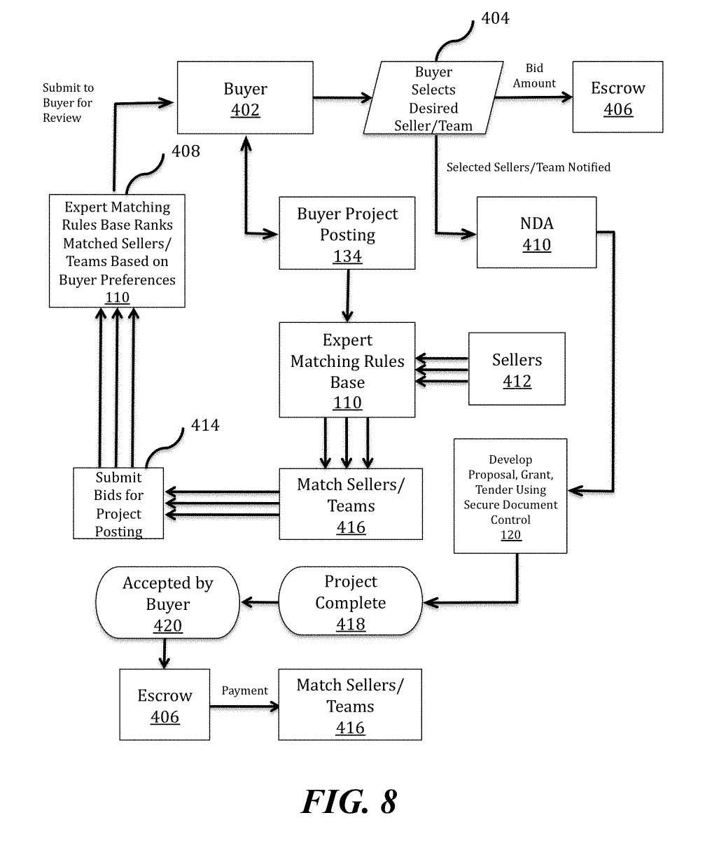

FIG. 8 shows a diagram of buyer utilizing reverse auction 130 and expert matching rules base 110 to select qualified sellers. Buyer may utilize reverse auction 130 to identify the most suitable seller, plurality of sellers or high performance team, made up of multiple sellers, at the best price. Buyer may utilize reverse auction 130 to bid for a single task for a brief time, or a complex multi-task project by a team of qualified professionals. Buyer may post a project posting on 134. Buyer may seek competitive bids from plurality of sellers or teams. Specific requirements for proposal support by labor category, level of effort and timing of the delivery of service on project posting 134 may be entered by buyer. FIG. 6 shows the required information to be inputted onto project posting 134.

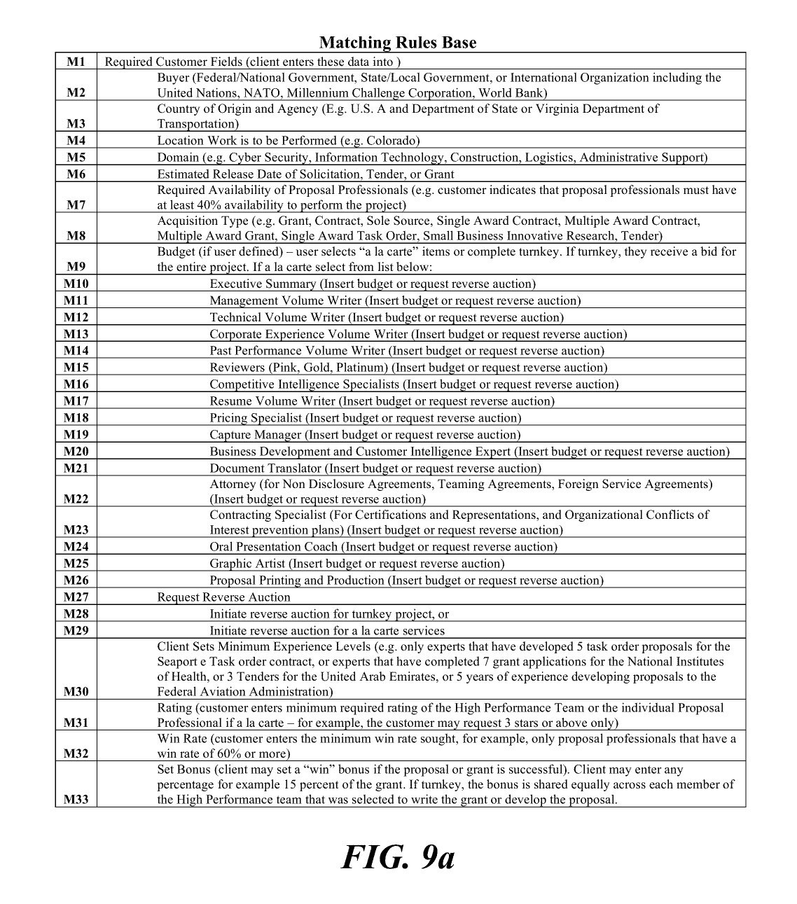

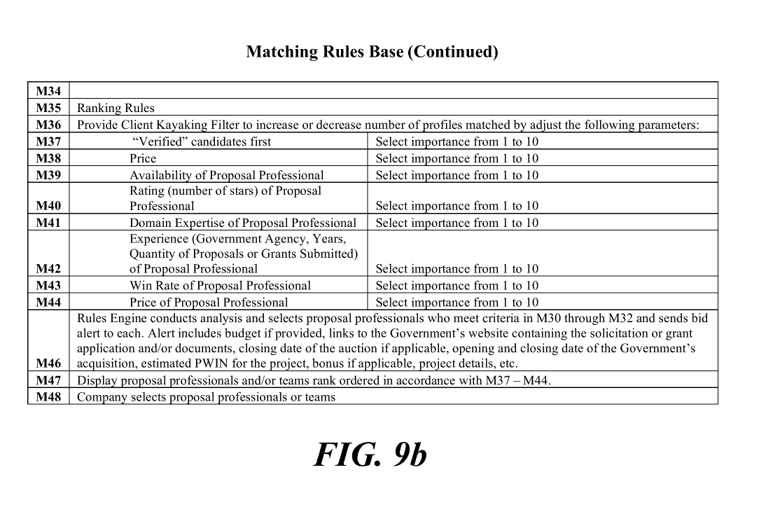

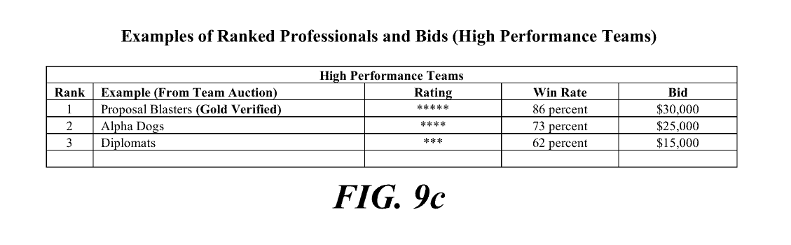

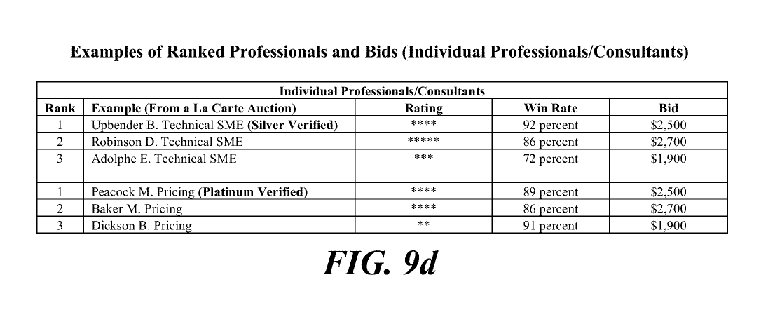

Expert matching rules base 110 matches plurality of sellers to the project posting and generates matched seller, plurality of sellers or teams 416. FIG. 9a shows rules base for expert matching rules base 110. Expert matching rules base 110 selects sellers that match criteria in project posting 134. FIG. 6 shows information posted on project posting 134. Information may include project description as outlined in the identified opportunity and desires of buyer, such as, verification status of seller or ratings of seller. Matched seller, plurality of sellers or teams are notified of their match to buyer. Interested seller, plurality of sellers or teams may submit bids 414 in response to project posting. Step 408 shows seller, plurality of sellers or teams ranked based on project posting criteria through expert matching rules base 110. FIG. 9b shows ranking rules executed in expert matching rules base 110. Sellers and high performance teams with a likelihood to be able to assist buyer are ranked, shown in FIGS. 9c and 9d. Buyer reviews qualifications and cost proposals and selects desired seller, plurality of sellers or team to complete project 404. Buyer may form a virtual proposal team by selecting individual sellers or plurality of sellers. Buyer may also select a fully formed high performance team 114 to develop the proposal, grant, tender, or cooperative agreement or discrete sections of the proposal, grant, tender, or cooperative agreement. The selected seller, plurality of sellers or team are notified and non-disclosure agreement 410 automatically sent to selected seller, plurality of sellers or team. Buyer deposits bid amount in an escrow account 406 through payment engine 116. Buyer and seller, plurality of sellers or team may utilize secure document control 120 to exchange documents. Upon completion of project 418, buyer reviews and approves the work 420. Once buyer accepts the document, payment is released from the escrow account 406 to seller, plurality of sellers or team.

The reverse auction process lowers prices approximately 4% to 40% and provides more choices for buyers, while it simultaneously solves a chronic problem in the Government proposal consulting business—timely payment. In the preferred embodiment, sellers may be paid upon completion of the work rather than submit an invoice and follow up for a payment cycle that sometimes delays payment by 30 or 60 days or even more.

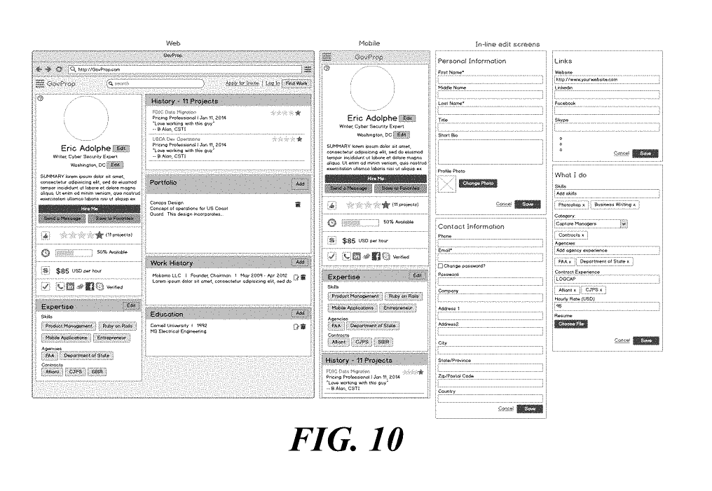

FIG. 10 shows screen shot of sellers profile page. Seller profiles may include general personal and professional information, and a description of each project awarded to the seller shown in a project profile. Project profiles provide a high level summary of each project including percent completed, win probability for each project, bonus available if the company wins the contract, grant, or tender, title of the project, reference number of the Government invitation, make up and membership of each project team, status or percent of completion for each component of the project, status of key personnel recruiting, identification of competitors, price targets, win themes, discriminators, and Government bid documents.

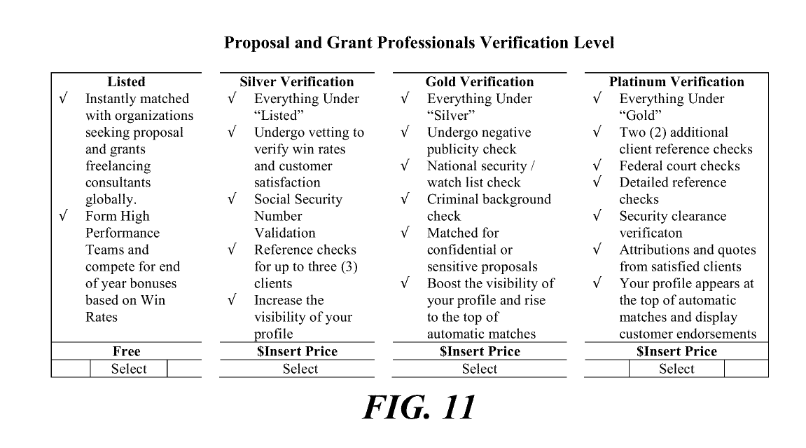

FIG. 11 shows verification levels for sellers. For no fee, sellers may be Listed with no verification. This verification level provides the seller matching opportunities with buyers, ability to become a part of high performance team, and compete for year end bonuses. For a fee, sellers may be listed with Silver verification. Silver verification level provides the seller with Listed features, as well as, undergoing vetting to verify win rates and customer satisfaction, social security number verification, up to three reference checks and increased visibility of seller's profile. For an increased fee, sellers may be listed with Gold verification. Gold verification level provides the seller with silver verification level features, as well as, undergoing negative publicity check, National security or watch list check, criminal background check, matched for confidential or sensitive proposals, for example, proposal requiring top secret clearance of key personnel, and boost visibility of seller's profile and rise to the top of automatic matches. For a further increased fee, sellers may be listed with Platinum verification. Platinum verification level provides the seller with Gold verification level features, as well as, two additional reference checks, Federal courts check, detailed reference checks, security clearance verification, attributions and quotes from satisfied clients, and seller's profile appears at the top of automatic matches and displays customer endorsements. Payment for verifications may be made through payment engine 116.

Sellers use tools supplied by the application 100 to complete the proposal, grant, tender, or cooperative agreement documents. FIG. 3 shows trending analytics 124. Trending analytics 124 provides agency or industry trending information. Sellers may utilize trending analytics 124 to maximize the potential for success.

In another embodiment, sellers may also extract market intelligence from the buyer's user interface 105 or the alert and push notifications 122 to create win themes and discriminators for incorporation into the proposal and to maximize the potential for success.

Sellers may also utilize proposal/grant key personnel resume matching rules base 128 to match resumes of required key personnel to resume databases. Sellers may extract those resumes and insert them into the proposal, grant, tender, or cooperative agreement documents. When buyer is responding to a solicitation or grant application for services, the document typically includes resumes of personnel including but not limited to key personnel, subject matter experts, and program managers. Under current methods, buyers hire recruiters to identify people that would be highly desirable to the Government agency. However, in an embodiment, buyer or seller identifies the personnel position requirements and utilizes proposal/grant key personnel resume matching rules base 128 to match the requirements against a database containing resumes. The resumes are presented to the buyer or seller for selection. When the buyer or seller accepts the resume or resumes, the resumes are inserted into the proposal document. A pre-determined fee is paid via payment engine 116 to the external database owner of the resume. Grant, proposal, cooperative agreement, tender workflows 108 generates a Letter of Intent from its template repository and submits the Letter of Intent to the buyer's human capital management department or hiring office that initiates negotiations. If the resume is rejected, secure document access control 120 automatically deletes the resume to prevent reuse.

Buyers and sellers may communicate through the secure document access control 120 which facilitates secure communications and document exchanges via the network 206 through buyer terminal 200, seller terminal 202, and administrator terminal 204, shown in FIG. 1.

In an exemplary embodiment, sellers may use the secure document access control 120 to review and edit the proposal, grant, tender, or cooperative agreement documents. Secure document access control 120 ensures that version control is maintained and that only the sellers on a need to know basis may view certain sections of the proposal or grant application. For example, a Pricing Specialist may be allowed to view the entire proposal or grant application, whereas the graphic artist may only be allowed to view certain sections of the document. Further, a resume writer may only be allowed to view resumes and may not be allowed to view or edit pricing and technical sections of a proposal. Buyer and/or a Proposal Manager using the secure document access control 120 determine the access control.

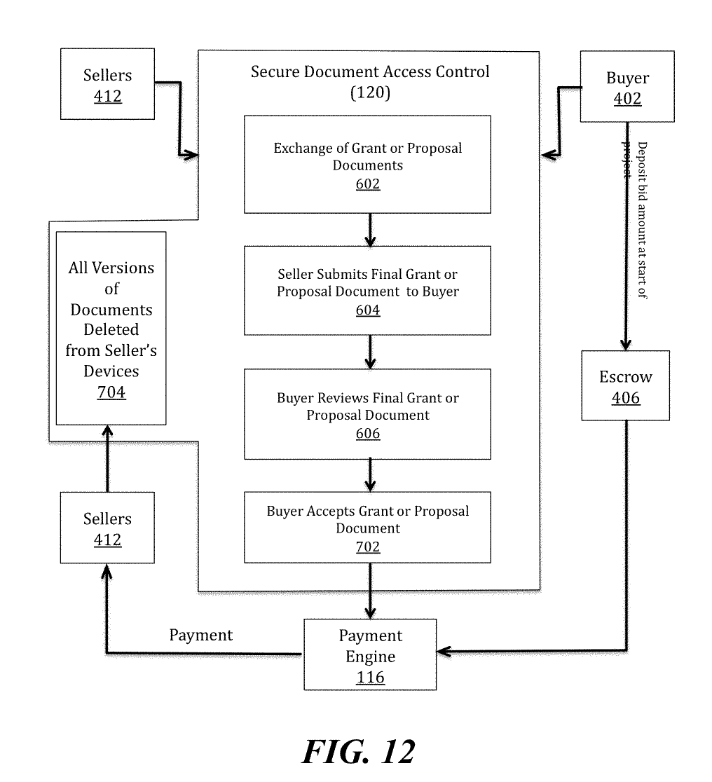

FIG. 12 shows secure document access control 120 utilized by buyer and seller, plurality of sellers or team. Step 602 shows buyer and seller, plurality of sellers or team exchange multiple revisions of documents. Step 604 shows seller, plurality of sellers or team submits final document to buyer. Step 606 shows buyer reviews final document submitted by seller, plurality of sellers or team. Step 702 shows buyer accepts seller's, plurality of seller's or team's document. Seller, plurality of sellers or team receives payment through payment engine 116. Payment engine 116 immediately pays seller, plurality of seller's or team upon buyer's acceptance of document from escrow account 406. Buyer deposits bid amount at start of project into escrow account. Upon receipt of payment by seller, plurality of sellers or team, step 704 shows all versions of the document including all drafts that have been rendered using the secure document access control 120 is automatically deleted from every location and device that was used to access or view the proposal, grant, tender, or cooperative agreement document by the seller, plurality of sellers or team.

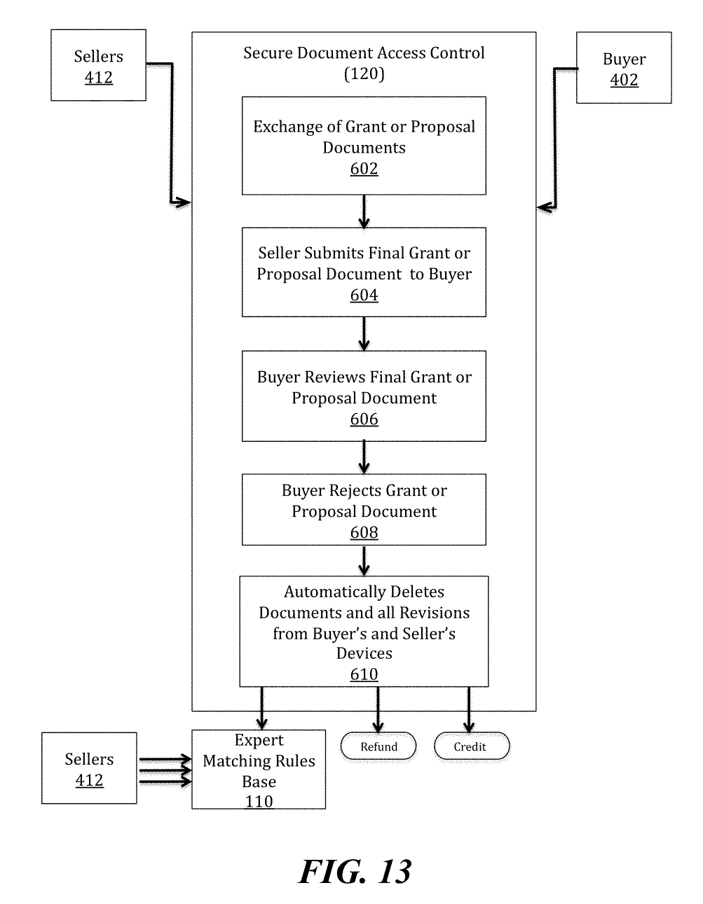

In another embodiment, FIG. 13 shows similar steps as in FIG. 12. However, in step 608 buyer rejects seller, plurality of seller's or team's document. Step 610 shows secure document access control 120 automatically deletes the work products and any revisions, from the buyer's and seller's computers and any other devices used to view the documents. Expert matching rules base 110 automatically attempts to re-match buyer with another seller.

In another embodiment, buyer may send the final proposal, grant, tender, or cooperative agreement document to a commercial printer via the secure document access control 120 and external server 316 for printing and production. Commercial printers may provide nationwide or global printing of the document. Commercial printers may be located at closest location to Government agency or buyer. Alternatively, buyer may send the final proposal, grant, tender, or cooperative agreement and a template delivery receipt directly to the Government agency if electronic delivery is specified in the Government's documents.

In another embodiment, Government agencies may issue amendments or modifications to the original documents requiring continued iterations of proposal, grant, tender, or cooperative agreement documents. Buyer may negotiate additional work arrangements in FIG. 6 to address changing Government requirements, which is typical in this community of practice. Work arrangements may include fixed price, hourly rate or price per page.

After delivery of proposal to the Government, the Government may issue Evaluation Notices (ENs), request Final Proposal Revisions or Best and Final Offers (BAFOs) or other forms of negotiation, which may require additional support from the original proposal experts. Buyer may initiate direct communications with seller, plurality of sellers or team through the seller's user interface 106 without initiating an auction or match. Buyer may negotiate additional work arrangements in FIG. 6 to address changing Government requirements, which is typical in this community of practice. Work arrangements may include fixed price, hourly rate or price per page.

After completion of all aspects of the project, buyer completes a survey, which assesses each seller's or team's performance. The survey is used to automatically update the information in the seller's user interface 106. The updated information may include whether or not the proposal, grant application, tender, or cooperative agreement was successful, timeliness and quality of the seller's or team's work, assessment of the seller's level of expertise in the subject area, rating (e.g. 1 star, 2 stars, 3 stars, 4 stars), and other factors.

In an embodiment, after the Government agency notifies the award of proposal, grant, tender, or cooperative agreement, buyer may generate a debrief report using the PWin calculator 126a to determine strengths and weaknesses and develop strategies for improving buyer's chances on future proposals, grants, tenders, or cooperative agreements. Copies of the debriefs are securely stored in file storage 312 for future reference. The debrief is accessible via buyer's user interface 105 and may be shared with invited sellers via the secure document access control 120. The embodiment enables all parties involved in the proposal development process to analyze the quality and effectiveness of the effort for a specific proposal. PWin calculator 126a is a tool to provide feedback, lessons learned and continuous improvement.

In another embodiment, if the proposal, grant, tender, or cooperative agreement is successful, application 100 automatically releases the bonus if any, from escrow, via the payment engine 116. If the proposal, grant, tender, or cooperative agreement was not successful, the bonus is returned to buyer or credited against buyer's account.

In another embodiment, on an annual, semi-annual, or quarterly basis, application 100 calculates the success rates or win rates of sellers 106 and teams 114 and selects the seller and or team that achieved the highest calculated win rates. Win rates may be displayed on the team scoreboard 118 and seller or team with the highest PWin receives payment of a bonus from the payment engine 116. For example, in FIGS. 9c and 9d, Team Proposal Blasters and individual Upbender B. would receive a bonus. If the calculated win rates are tied, then the bonus is split equally amongst sellers and/or teams. FIG. 9c shows high performance teams ranked based on matching rules base in FIG. 9b. FIG. 9d shows a la carte selection of sellers. Buyer may request on project posting 134 specific types of sellers. For example, FIG. 9d shows Technical Subject Matter Experts (SME's) ranked and Pricing personnel ranked by matching rules base.

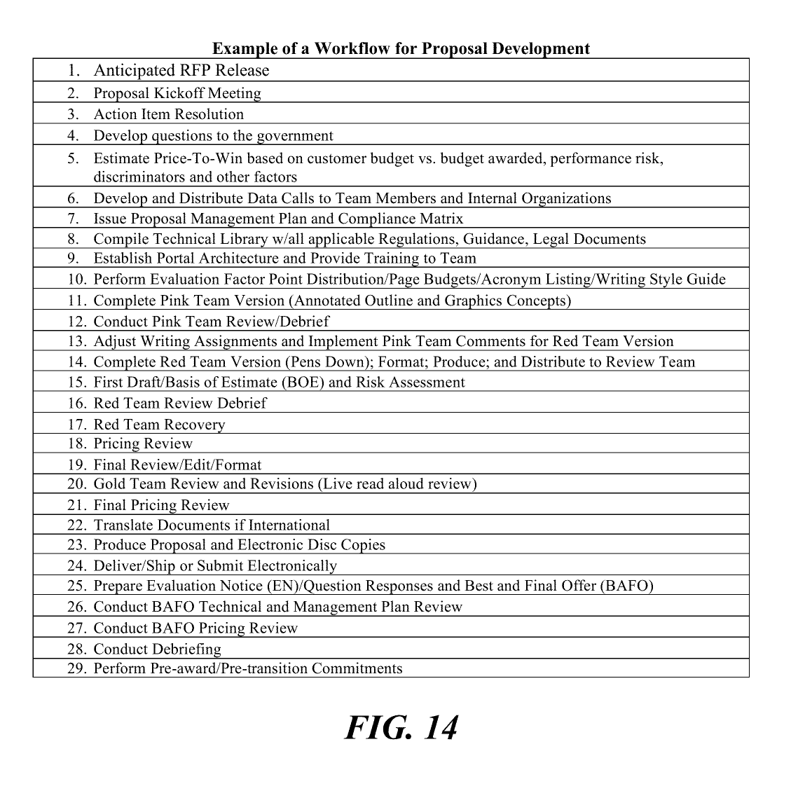

In another embodiment, industry-specific workflows and templates for completing proposal, grant, tender, or cooperative agreements are facilitated through grant, proposal, cooperative agreement, tender workflows 108. For example, FIG. 14 shows a Workflow Template for proposal development encoded in 108. Other workflows, and templates for grants, tenders, or cooperative agreements are similarly encoded in 108. Workflows 108 electronically overlays the proposal or grant development cycle, and templates on a schedule with automated reminders of key activities for each phase of the proposal development cycle. This embodiment enables sellers, plurality of sellers or teams and buyers to track progress, monitor changes and assure that the entire team is on schedule. This embodiment also enables buyers to rapidly respond to high volume task order requests for proposals or other solicitations or task orders or solicitations that have a shortened submission due date. For example, a typical proposal may be due in 30 days; whereas a shorten due date might be 7 days or less.

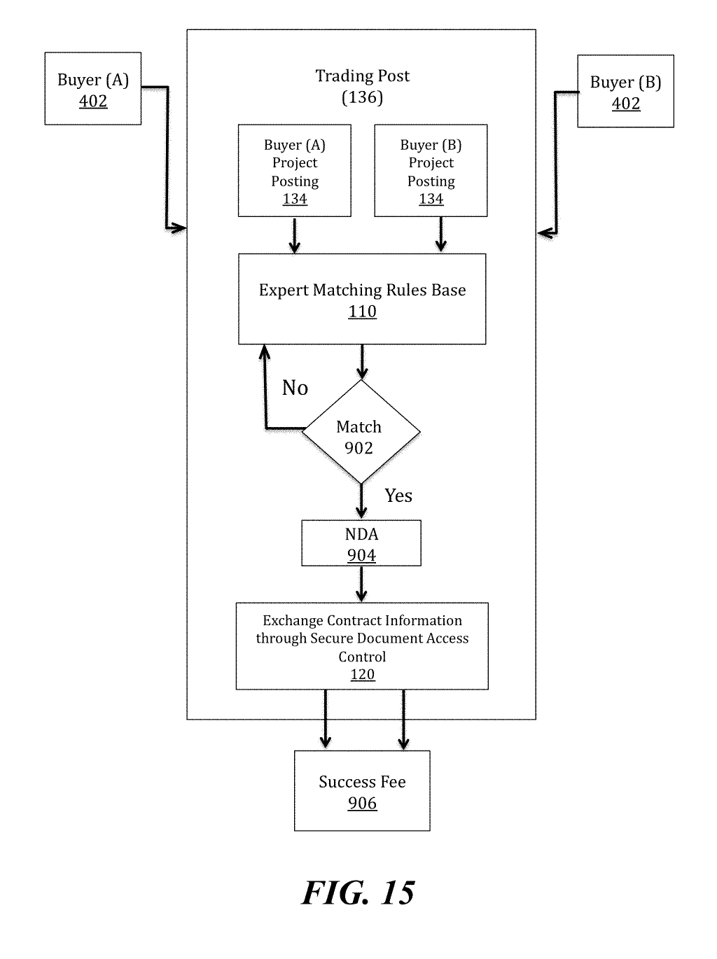

FIG. 15 shows trading post 136 where buyers may buy, sell or trade contracts or positions. In another embodiment, trading post 136 may enable companies to electronically buy, sell and trade government contracts and grants. Electronically buy, sell and trade staffing positions on government contracts and grants. Electronically buy, sell and trade pre-existing bid and proposal templates. Electronically select subcontractors and suppliers to form a team to pursue Government contracts and tenders, and grants. The system also identifies subcontractors and suppliers based on core competencies, products, experience, and other attributes and areas of interest assigned by the company. For example, on the trading post 136, Buyer A submits project information and posts contract for sale on project posting 134. On the trading post 136, Buyer B submits project information and posts desire to buy contract on project posting 134. Matching rules base 110 matches Buyer A to Buyer B. Step 902 shows if there is a match, a non-disclosure agreement is submitted to both buyers and they may exchange contract information through secure document access control 120. Success fee 906 may be awarded to administrator. If step 902 shows no match, then matching rules base attempts to find a match.

Application programming interface (API) 140 may allow market intelligence products to connect to the application 100. Server integration 142 may communicate to different or alternative servers.

Also, creating and tracking IRS Form 1099 information is cumbersome for businesses and organizations, as well as employees. Form 1099 generator 112 keeps track of fees paid and creates an on-line summary for the purpose of mandatory IRS reporting. At the end of the year a downloadable version of the final Form 1099 for the year is available for both buyers and sellers to complete their tax records for the year. Form 1099 generator 112 collects data from administrator file storage for each seller for the year, consolidates the data and automatically inserts data into IRS Form 1099 for United States sellers only. Form 1099 generator 112 prompts seller to enter tax payer identification number and generates consolidated Form 1099 and deletes tax payer identification number. Buyer receives copy of Form 1099 for their records.

As one non-limiting example, multiple experts in the fields of program management, price professional, grant writers and proposal writers register in the application and their profile stored in a database. Government contractor, CleanAir purchases subscriptions in the application and their profile stored in a database. CleanAir is aware of an opportunity with the Department of Energy and needs a pricing professional to price out the proposal. CleanAir utilizes price estimator to determine cost of the project using reverse auction. CleanAir utilizes PWin calculator to determine probability of winning the opportunity. CleanAir posts a project description and requests bids from pricing professionals. CleanAir may either request an open bid or place a budget on the bids. Expert matching rules base matches project description criteria with pricing professionals. Matched pricing professionals are notified of the opportunity. Matched pricing professionals respond with bids. The application ranks the bids based on project description criteria and desired attributes of the pricing professional that is identified by CleanAir. CleanAir evaluates all bids and selects desired pricing professional. Pricing professional automatically receives non-disclosure agreement (NDA) for signature. After execution of NDA, a copy is posted on pricing professional's file and CleanAir's file in file storage. CleanAir deposits bid amount into escrow account. CleanAir and pricing professional conduct secure exchange of documents on secure document control. Work is completed by pricing professional and delivered to CleanAir. If CleanAir accepts work, then pricing professional is automatically paid from escrow account through payment engine, CleanAir completes expert review/rating, automatically uploaded onto pricing professional's profile: timeliness, quality, expertise of subject matter, whether awarded or not, rating (1-4 stars), pricing professional completes CleanAir review/rating, all versions of documents deleted from all devices that pricing professional used, and auctions, pricing professional's, and CleanAir's database information updated. If CleanAir does not accept work, then all versions of documents are deleted from all devices that pricing professional and CleanAir used and application automatically rematches CleanAir with pricing professionals. Matched pricing professionals respond with bids, then process repeats until CleanAir accepts work from a pricing professional. If CleanAir does not utilize a pricing professional, then they may be given a refund or credit.

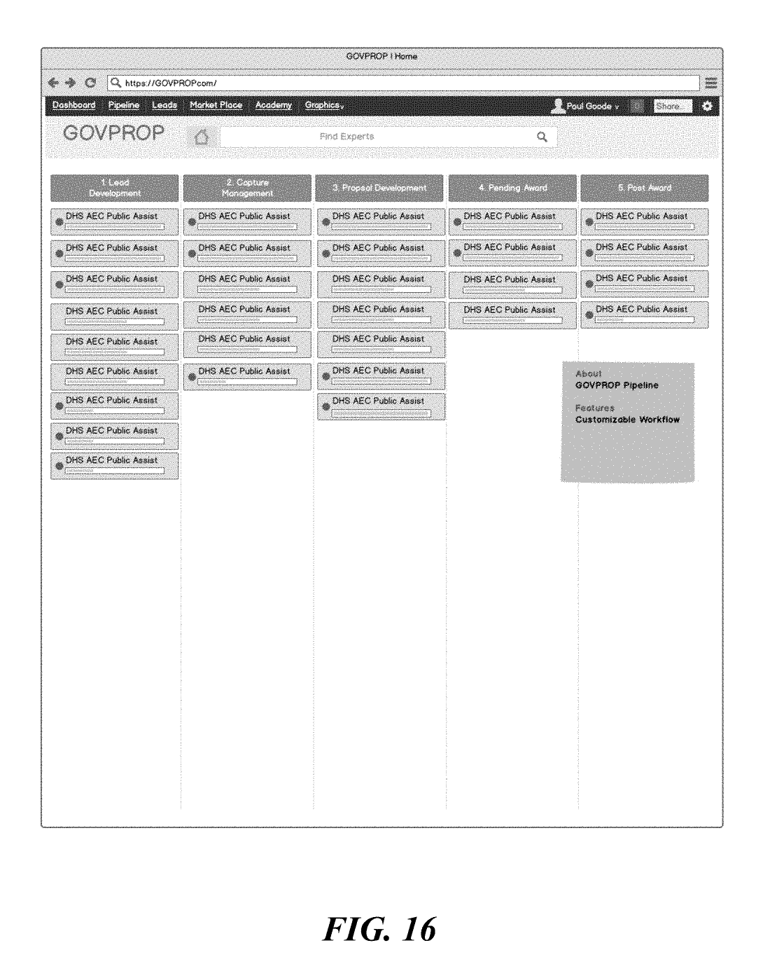

FIG. 16 shows a pipeline tool feature. The software mines data from several government systems including, but not limited to, USASpending.gov, Federal Procurement Data System (FPDS), Federal Business Opportunities (FBO), and State.gov. Using the matching engine, the software matches the contract and grant opportunities against the user's (both contractor and consultant) profile. The leads are then stored in the “1. Lead Development.” Each of the buckets (1 through 5) includes a set of user defined conditions and workflow that determine when a contract or grant lead in the pipeline moves from 1. Lead Development to 2. Capture Management to 3. Proposal Development to 4. Pending Award to 5. Post Award. For example, to move from 1 to 2, the user may set any number of rules. For example, 1. Obtain a NDA, 2. Meet with the customer, 3. Identify competitors rules could be set. A dashboard illuminates red in the beginning and then moves from red to yellow to green. Once each of the conditions is met, the dashboard illuminates green and that opportunity moves from 1. Lead Development to 2. Capture Management. The next set of conditions could be set by the user to move to 3. Proposal Development. Once, those set of conditions have been met, the user could define a next set of conditions to move to 4. Pending Award. Once, those set of conditions have been met, the user could define a next set of conditions to move to 5. Post Award. The pipeline tool also keeps track of revenue targets for each user in the organization. For example, in order to grow a Government contracting business, the company's pipeline must be valued at 15 times the company's annual revenue. So if the company has an annual revenue of $2 Million, the total value of leads in the company's pipeline should be $30 Million. The dashboard items: 1. Lead Development, 2. Capture Management, 3. Proposal Development, 4. Pending Award and 5. Post Award, go from red to yellow to green to let the company know if they are meeting pipeline goals.

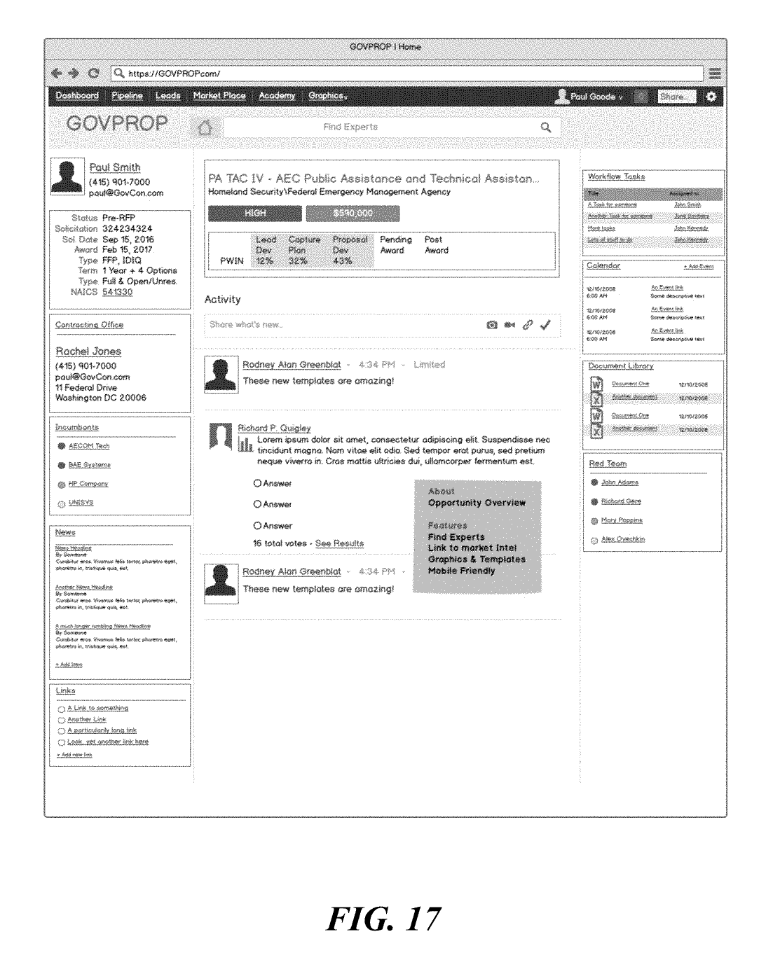

FIG. 17 shows the detail drill down of the pipeline tool feature shown in FIG. 16. When you click on any of the individual opportunities listed in FIG. 16 above, the user will view this detail drill down. The detailed view is a single business development epicenter. The salesperson can in one view see everything needed to successfully pursue an opportunity. For example, customer details including points of contact, status of the opportunity (has the solicitation been released?), potential competitors, intelligence, a calendar used to assign and schedule bid and proposal activities, proposal document library, which is where all material needed to write this specific proposal is stored. The library is highly secure preventing unauthorized users from downloading, copying, printing, forwarding, or copy and pasting information without permission. This feature also includes a proposal review team drafting tool. The user can enter parameters such as last season's proposal win rates, knowledge of the customer, knowledge of competitors and establish weights for each parameter. The software will then draft and suggest proposal specialists to review the proposal. Also, this feature has a teammate drafting tool as well. The teammate drafting tool drafts other companies that the contractor should consider teaming with to maximize their chances to win.

While embodiments have been described in terms of a system, method and device, other embodiments are also possible. The corresponding structures, materials, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated. It will be apparent to those of ordinary skill in the art that many more embodiments and implementations are possible that are within the scope of the disclosure. It is intended that all such additional systems, methods, features and advantages be included within this description and this summary, be within the scope of the disclosure, and be protected by the following claims.

What is claimed is:

1. A computer implemented method for identifying a seller, comprising:
receiving a buyer request for a seller;
creating a buyer posting, the buyer posting indicating a government contract or grant;
creating multiple seller profiles, each seller profile created by a separate seller;
wherein the buyer requests bids from the sellers; and wherein the buyer selects desired seller.

2. The method according to claim 1, wherein the buyer is a government contractor.

3. The method according to claim 2, wherein the seller is a proposal professional.

4. The method according to claim 3, further comprising:
estimating the probability of award of the government contract or grant.

5. The method according to claim 4, further comprising:
automating reverse auction of proposal development and grant application project costs.

6. The method according to claim 1, further comprising:
acceptance by the desired seller and payment to the desired seller.

7. The method according to claim 5, further comprising:
selecting other desired sellers.

8. The method according to claim 7, further comprising:
maintaining a virtual proposal team scoreboard.

9. The method according to claim 8, further comprising:
generating government forms for the proposal professionals to be filed with the internal revenue service.

10. The method according to claim 9, further comprising:
securely transferring government proposals between proposal professionals.

11. A system for identifying a seller, comprising:
a buyer terminal, wherein a buyer can request a seller;
a seller terminal, wherein a seller can create a profile;
wherein the buyer can post a government contract or grant;
wherein the seller can post a bid; and
wherein the buyer selects desired seller.

12. The system according to claim 11, wherein the buyer can request a probably of award of the government contract or grant.

13. The system according to claim 12, further comprising:
automating reverse auction of proposal development.

14. The system according to claim 13, further comprising:
the seller accepting the position and the seller receiving payment for services rendered.

15. The system according to claim 14, further comprising, the buyer selecting multiple sellers.

16. A method of selecting a proposal professional, comprising:
receiving a buyer request for a seller at a buyer terminal;
creating a buyer posting, the buyer posting indicating a government contract or grant;
creating multiple proposal professional profiles, each proposal professional profile created at a separate seller terminal,
wherein the buyer requests bids from the multiple proposal professionals; and wherein the buyer selects the desired proposal professional.

17. The method according to claim 16, further comprising:
estimating the probability of award of the government contract or grant.

18. The method according to claim 17, further comprising:
performing electronic review of a government proposal.

19. The method according to claim 18, further comprising:
selecting multiple proposal professionals.

20. The method according to claim 19, further comprising:
estimating the price to complete a government proposal to respond to the government contract or grant.
